(19) United States
(12) Patent Application Publication
(10) Pub. No.: US 2005/0197885 A1
(43) Pub. Date: Sep. 8, 2005

(54) System and method for providing campaign management services

(76) Inventors: Derek Hung Kit Tam, Reston, VA (US); Connor C. Kyle, Ashburn, VA (US); Robert C. Lovell JR., Leesburg, VA (US)

Correspondence Address: Lawrence D. Eisen;SHAW PITTMAN LLP, 1650 Tysons Boulevard, McLean, VA, 22102, US

(21) Appl. No.: 10/837,696

(22) Filed: May 4, 2004

Related U.S. Application Data
(60) Provisional application No. 60/548,962, filed on Mar. 2, 2004.

(51) Int. Cl. G06F 17/60; G01N 25/72

(52) U.S. Cl. 705/10

(57) ABSTRACT

A system and method for allowing users to participate in a campaign, preferably using SMS messaging. The system includes a first layer configured to receive information from a user via a user interface, a second layer configured to extract data relevant to the campaign from the information received by the first layer, and a third layer configured to compare the extracted data to requirements of the campaign and, if the extracted data complies with the requirements of the campaign, to store the extracted data in a database associated with the campaign.

This application claims the benefit of U.S. Provisional Application No. 60/548,962, filed Mar. 2, 2004, which is herein incorporated by reference in its entirety.

### BACKGROUND

1. Field of the Invention

The present invention relates generally to providing campaign management services. More particularly, the present invention relates to utilizing the Short Message Service (SMS) to enhance campaign management services.

2. Background of the Invention

SMS is a convenient and easy to use messaging application available to users of mobile telephones and other wireless devices. SMS offers a new way to communicate by sending text or data messages between mobile phones or between a mobile phone and information devices, such as a personal computer (PC), a PDA (personal digital assistant), or a handheld email/calendar organizer (e.g., a RIM device). Messages are composed of words, up to 160 characters in length for Latin alphabets (about 30 to 40 words) and 70 characters for non-Latin alphabets like Arabic and Chinese. To send, text messages are keyed into a mobile phone keypad or other information device. Received text messages are presented on the mobile telephone's screen.

Introduced in Europe and the United Kingdom (U.K.) during the mid-1990s and in Asia soon thereafter, SMS encountered great enthusiasm, especially among teenagers and young adults. And although SMS had originally been conceived as a paging system, users quickly adapted text messaging for their own objectives. By the late 1990s, GSM carriers in both Europe and the U.K. had connected their networks, allowing their subscribers to exchange text messages across other GSM carriers. In 2001, 700 million mobile phone users worldwide sent 20 billion messages every month, making SMS the fastest growing service in the wireless industry.

A portion of messages that are sent via SMS are not sent to another telephone or PDA as in a Person-to-Person communication, but are instead directed to a central location. While the central location could have a regular 10-digit telephone number as does a typical mobile telephone, SMS messages directed to a central location are often so-directed using a so-called short code address. A short code address is a convenient short number that identifies a central location to which an SMS message can be sent. A typical application of short code use is Tele-voting in which, for example, a television program flashes on the screen instructions to “Send an SMS message to 8012 to vote yes.” At present, these tele-voting systems are limited to a single wireless carrier (i.e., only those that are subscribers to the wireless carrier can participate). Co-pending U.S. patent application Ser. No. 10/742,764, entitled, “Universal Short Code Administration Facility” describes a system that enables short codes to be used across different wireless carriers and thereby make short codes universally available to all subscribers regardless of their wireless service provider.

Despite the increased use of SMS messaging, there are still uses of SMS messaging that have yet to be described or promoted.

### BRIEF SUMMARY OF THE INVENTION

The present invention represents a continuing effort to deploy value-added services atop core message processing, routing, and delivery infrastructure for SMS. One such value-added service is a comprehensive Campaign Manager (CM) service. One advantage of the CM service of the present invention is to provide a flexible, extensible, and full-featured framework that allows for one or more initiatives, such as, one-way voting, two-way voting, mobile marketing, and interactive services, among others, using SMS technology and infrastructure.

In one aspect, the present invention is directed to a system for allowing users to participate in a campaign, e.g., an advertising campaign, created by a campaign owner or sponsor. The system is preferably implemented over multiple layers or tiers that provide separate functions used in supporting the CM service. Although the system is described in layers or tiers, one of skill in the art will appreciate there are other hardware and software implementations that can be used to provide CM service.

The present invention preferably includes a first layer, such as a protocol layer, configured to receive information from a user via a user interface. Typically, the user may be responding to, e.g., advertisement material found in a printed document, on a web-page, or heard over the radio. Access to this first layer may be provided to other entities, such as campaign owners or interested third-parties to monitor the results of the campaign.

A second layer, or workflow layer, is preferably configured to extract data from the information received by the first layer that is relevant to the particular campaign the user is responding to. One or more sub-routines may be defined for each campaign that provide verification of the user, verification of the format of the information, and determination as to whether the campaign is currently active. One of skill in the art will appreciate that the number of sub-routines can vary from campaign to campaign and generally will be determined by an operator or owner of the system with the input of the campaign owner.

Finally, the system preferably includes a third layer, or application server layer, configured to compare the extracted data to requirements of the campaign. These requirements may be stored in databases or are otherwise accessible by the third layer. If the extracted data complies with the requirements of the campaign, the third lay stores the extracted data in a database associated with the campaign. This database may be mined by the campaign owner through the first layer to assist in marketing decisions or to better respond to user wants and needs.

In another aspect, the present invention is directed to a method for employing SMS infrastructure for running a campaign. The method includes receiving information from a user via a user interface in response to some external stimulus, such as an advertisement. Next, the data relevant to the campaign is extracted from the information received via the user interface. Finally, the extracted data is compared to the requirements of the campaign to determine if the data is acceptable. If the extracted data is acceptable, the extracted data is stored in a database associated with the campaign.

These and other features and their attendant advantages will be more fully understood upon reading the following detailed description in conjunction with the associated drawings.

### BRIEF DESCRIPTION OF THE DRAWINGS

FIG. 1 is a schematic drawing of a Campaign Manager framework according to an embodiment of the invention.

FIG. 2 is a schematic representation of a schedule for a number of campaigns supported by the Campaign Manager framework according to FIG. 1.

FIG. 3 is a schematic drawing of a Campaign Manager framework according to a second embodiment of the invention.

### DETAILED DESCRIPTION OF THE INVENTION

The CM service of the present invention is preferably implemented using a comprehensive SMS message processing, routing, and delivery infrastructure. Such an infrastructure has been described in co-pending U.S. patent application Ser. No. 10/426,662, entitled, “An Intermediary Network System And Method For Facilitating Message Exchange Between Wireless Networks”, and U.S. patent application Ser. No. 10/742,764, entitled, “Universal Short Code Administration Facility”, each of which is hereby incorporated herein by reference in its entirety. However, those skilled in the art will appreciate that the following description of the CM service of the present invention is not limited to such infrastructures.

In a preferred implementation, the CM service is used to provide several services to Mobile Subscribers (MSs) including one-way voting, two-way voting, mobile marketing, and interactive services, among others. For example, one-way voting may involve an MS who notices an advertisement in a newspaper describing a manufacturer's introduction of a new product. The advertisement asks the MS to vote on a favorite product color by sending an SMS message to a particular address (e.g., a Telephone Number (TN) or a short code, such as a universal short code (USC)). The campaign may specify specific codes for each color or differentiate based on free-form text provided by the MS. The MS dispatches an SMS message to the indicated address and optionally receives back a response SMS message that acknowledges the receipt of the vote. Received votes are totaled, with running totals made available for display to authorized administrators, campaign owners, etc., through, e.g. a Web-based interface. Advertisers, manufactures, marketing, and tele-voting could all benefit from such an arrangement, although, CM service is not limited to these entities.

Similarly, two-way voting extends the uni-directional aspect of a one-way voting initiative to include bi-directional ‘conversational’ communication between the MS and the CM (e.g., MS SMS message→CM, CM SMS message→MS, MS SMS message→CM, etc.). Essentially, additional information can be collected by proceeding through a series of interactive questions and responses until the communication is terminated by either the MS or the campaign.

In a particular use of the CM service, mobile marketing campaigns can be easily implemented. In a preferred embodiment, an MS will see or hear an advertisement that will direct the MS to a Web site at which the MS can register for the campaign. This initial registration step can be performed via a mobile device such the MS's mobile phone (assuming it is Internet/WWW-enabled), or via a conventional wired computer. At the Web site the MS preferably creates an account, identifies himself (e.g., provides a TN, answers various demographic and/or psychographic questions, etc.), and selects from the available marketing categories that are of interest to him. To complete the registration process an SMS message containing an encoded random value can be dispatched to the MS who, in turn, replies to complete the registration process. After the MS is registered, participation in subsequent marketing initiatives by the campaign owner can occur.

More specifically, on some basis (random, scheduled, etc.) outgoing questions are generated based on defined marketing campaign parameters, demographic and/or psychographic matches with registered MSs, etc. and are then dispatched to the recipient MSs via SMS messages. For each question to which an MS replies, the MS's account is credited with a defined amount (of cash, of a cash equivalent, etc.) that is subsequently redeemable.

Similar to mobile marketing campaigns, interactive services may be provided when an MS notices an advertisement for an interactive service (whose content might include weather updates, sports scores, airline flight change and other travel notifications, daily trivia snippets, etc.). The MS visits an associated Web site and creates an account, identifies himself (e.g., provides their TN, answers various questions, provides their credit card information for billing purposes, etc.), and selects from the available alert categories that are of interest to him. On a scheduled basis (which takes into account, for example, MS-defined ‘quiet periods’ during which messages should not be generated, such as late at night) outgoing SMS messages are generated based on the MS's selected categories and then dispatched to the MS. Depending on the extensive nature of the interactive service, the MS may be asked to provide billing information that the CM service can bill directly.

In preferred embodiments, for both mobile marketing campaigns and interactive services, the MS goes through a registration process where the MS supplied information can be verified so as preclude imposters from posing as a particular MS. Co-pending U.S. patent application Ser. No. 09/593,681, entitled, “Method And Apparatus For Providing Integrated Message Delivery to Wireless Devices Over the Internet” describes suitable ways to register and verify an MS for purposes of the present invention. This application is also incorporated herein by reference in its entirety. It will be apparent to one of ordinary skill in the art that there are other suitable ways to register and verify a MS.

Numerous examples are available of the practical application of the initiatives that are described above, including:
Movie, sport, political, etc. announcements.
A ‘traffic glimpse’ service where an MS can visit a public Web site, identify himself (provide a TN, answer various questions, provide credit card information for billing purposes, etc.), register to receive snapshots from one or more of the available roadways, intersections, etc. served by traffic monitoring cameras at scheduled day(s)/time(s) (e.g., perhaps 15 minutes in advance of the MS departing from home for the morning commute).
Question of the Day, Thought for the Day, Tip of the Day, etc. messages.

One of skill in the art will appreciate that additional initiatives, which leverage various combinations of the features and the functionality that are provided by the core message processing, routing, and delivery infrastructure and/or other pre-existing initiatives, are possible. In fact, one of the aspects of the present invention is the rapid, straightforward addition of new initiatives to the CM framework.

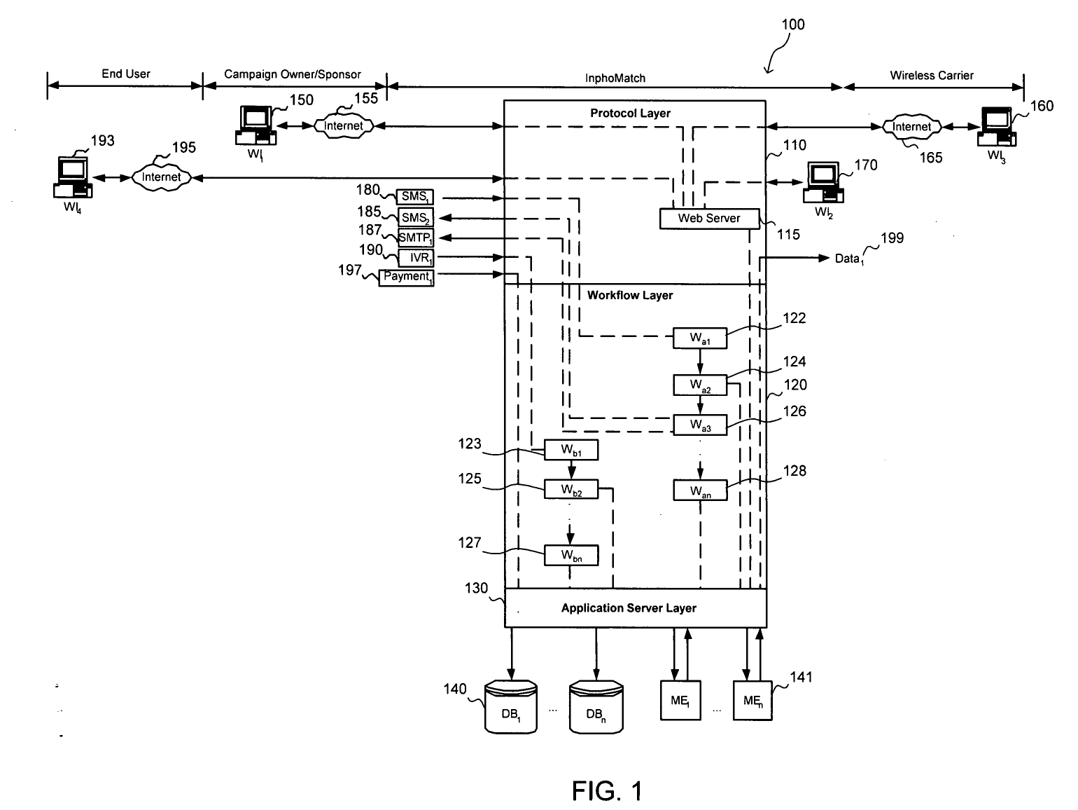

Having described several suitable services that may be provided from a CM service, implementation of a CM framework 100 to support CM service will be described using one-way voting as shown in FIG. 1. Generally, the CM framework 100 consists of three layers, a protocol layer 110, a workflow layer 120, and an application server layer 130. The CM service also include one or more databases 140 (DBₗ to DBₙ).

The protocol layer 110 provides support for all of the different ways in which entities may enter/exit the framework, such as, for example, web-based interfaces via a web server, inbound and outbound SMS messages, outbound Simple Mail Transfer Protocol (SMTP) messages, Interactive Voice Response (IVR) data feeds, among others.

The workflow layer 120 supports a flexible, extensible, and dynamically configurable workflow facility. A workflow sequence may quickly and easily be defined for a configured campaign. Since it is possible that numerous campaigns will exist at any single moment in time, multiple workflow sequences may exist at any single moment in time.

The application service layer 130 facilitates interactions between the individual components in the protocol layer 110 and the individual components in the workflow layer 120. Preferably, the application service layer 130 isolates and abstracts away details generated by accessing the different database environments such as, for example, provisioned campaigns or collected voting detail records (VDRs) that are created as a result of processing of votes during the life of the campaign. These details may be stored in one or more databases 140.

Also, MEₗ, . . . MEₙ 141 represent “Message Engines” that drive, for example, the generation of outgoing messages base on, among other things, individual campaign schedules and the “state” of the individual MSs within a campaign.

It should be apparent to one of skill in the art that other arrangements of the identified layers and databases may be possible and alternate (e.g., non-layered) implementation approaches are possible and within the scope of the present invention.

As seen in FIG. 1, there are a number of ways for a first entity 150 to access the CM framework 100, the most typical being via an internet interface 155. Access may also be provided via a dial-up connection, or any other circuit switched or packet switched network. Internet interface 155, in turn, connects to a web server 115. The first entity 150 may be a business, organization, or marketing group for a specific client. This entity 150 can monitor the activity of the campaign in real-time or near real-time through access to the web server 115, which, in turn, is in communication with the application server layer 130. For example, the first entity 150 may want to receive a running tally of the number of votes received over a specified time period.

In a preferred embodiment, the Campaign Manager (CM) platform contains a user management component so that, for example, when a user logs in to the system they may only ‘see’ those campaigns to which they have visibility (to which they have been granted access) and may only ‘do’ those things (create campaigns, edit campaigns, etc.) for which they have been granted rights. Therefore it is possible for a campaign owner to create and manage campaigns (to the extent that they have been granted such rights/permissions) rather than relying on a CM administrator to perform those tasks.

A second entity 160 may be a wireless carrier or some other communication company that wants to provide CM services to its subscribers. The second entity would also access the CM framework 100 through an internet interface 165 accessing web server 115. This internet interface may be the same as, or different from, internet interface 155 accessed by the first entity 150.

A third entity 170 is associated with the CM framework 100. For example, the third entity 170 may own or control the CM framework 100. In addition to monitoring the activity against a campaign, the third entity 170 may create new campaigns. For example, the third entity 170 can create the identifiers and description of the campaign; specify or assign telephone numbers, short codes, or universal short codes; input start date and time; and input end date and time as desired by a campaign owner.

The third entity 170 is preferably able to define the mechanics of the newly-created campaign. For example, the third entity 170 may specify the proper form of response (e.g. legal, valid, or correct), the appropriate work flow sequences, applicable parsing rules, and/or text for any outbound SMS/SMTP messages. The third entity 170 may also have the ability to modify or delete existing campaigns.

A mobile subscriber 193 may register, when the campaign is designed for registration, to participate in a campaign by connecting through an internet interface 195 that accesses the web server 115 and provides the appropriate details. In addition to registering with a campaign, the MS may be asked to provide a credit card to satisfy any billing requirements of a campaign.

Once a campaign is created, an MS may access a particular campaign by transmitting a message using SMS or some other recognizable message format to the assigned telephone number, short code, or universal short code. Once received by the CM framework 100, the information in the message is captured and processed through the appropriate work flow(s). For example, as shown in FIG. 1, CM framework 100 receives an SMS message 180 and, at work flow step 122, the CM framework 100 accepts the input from SMS message 180 and extracts the relevant data elements.

Next, at work flow step 124, the CM framework 100 queries the database 140 of provisioned voting campaigns to determine the appropriate campaign and to validate the vote and identify the specific parsing rules that are to be applied for that campaign. Once the results of the database query are known, the CM framework 100 may use a Dynamic Response Interpretation Engine (DRIE) to interpret the response. For example, if the campaign only wants to keep track of votes as “Y” or “N”, the DRIE will convert incoming free-form text into the appropriate vote format. The DRIE may support configurable keywords, string parsing, and any conventional examination activities.

Once the vote has been extracted, at work flow step 126, the CM framework 100 may send an outgoing SMS message 185 or a Simple Mail Transfer Protocol (SMTP) email 187 depending on the originating device of the vote. It should be appreciated that any suitable confirmation message may be sent. If the vote was not proper for some reason (e.g., the campaign may have not started, the campaign may have already ended, or the vote was not in an acceptable form), then a warning message may be sent at step 126 notifying the MS of the problem.

At step 128, the CM framework 100 records the collected vote to the campaign's voting detail record repository stored in one of the databases 140. This repository may store such data as date, time, voting campaign identifier, vote or answer/response, MS identifier, among other data.

If the voting campaign allows for voice voting, then the CM framework 100 can receive a data feed through an Interactive Voice Response (IVR) interface 190. Step 123 functions similarly to step 122 in that the data feed is accepted and the relevant data is extracted from the vote. Next, at step 125 the database of provisioned voting campaigns is queried to validate the vote. Finally, at step 127 the vote is recorded in the appropriate VDR repository for the campaign.

If there is a service fee associated with a particular campaign, the application service layer 130 communicates with an external platform to bill the MS supplied credit card via a payment interface 197.

Additionally, an outbound data feed 199 may be offered to external third parties to provide them with voting results in either real-time or near real-time. The data feed may be an Extensible Markup Language (XML)-based data feed or any other suitable data feed. The data feed 199 may be used to dispatch campaign information, campaign results, or other parameters to any of the participating entities (e.g., campaign owners, sponsors, or wireless carriers.)

It will be apparent to one of skill in the art that the various messages and interfaces described above are not exhaustive. Other messages and interfaces may easily be added to the framework. For example, a Web-based interface may be provided through which votes may be registered for a defined campaign. It is also apparent that the above list of activities for the identified interfaces is by no means exhaustive and that other activities may easily be added to an interface.

The physical realization for receiving or sending SMS messages 180, 185, SMTP email 187, IVR interface 190, and payment interface 197 may take different forms. For example, the data feed from an IVR system or from a third-party vendor providing IVR services may take the form of an XML document while (for, amongst other reasons, performance considerations) the inbound and the outbound exchange of SMS messages may be accomplished through a high-speed queue facility that is wrapped by or encapsulated within an Application Programming Interface (API).

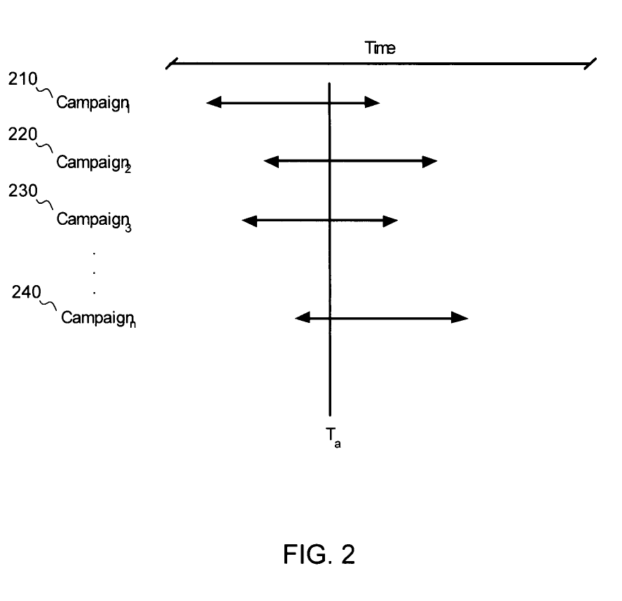

One other feature of the CM framework 100 is an intelligent, flexible, and extensible ‘sanity check’ capability. For example, in the case of a one-way voting initiative, at any given moment in time the CM framework 100 may have a series of provisioned campaigns, each campaign having (amongst other things) its own starting date/time, ending date/time, and maximum allowable messaging rate. As entity 170 attempts to provision a new campaign the CM framework 100 preferably examines the proposed campaign's starting and ending dates/times vis-à-vis the starting and ending dates/times of all of the existing (provisioned) campaigns and verifies that capabilities of the CM framework are not exceeded. These capabilities may be defined by how the hardware and software have been configured to support a defined maximum number of messages per second. For example, as seen in FIG. 2, at any given moment in time, Tₐ, there are a number of campaigns 210, 220, 230, and 240 that may potentially compete for system resources from the CM framework 100. The CM framework 100 will examine the maximum allowable messaging rate of each provisioned campaign and verify that, at any single moment in time Tₐ, the capabilities of the underlying CM framework are not exceeded.

It will be apparent to one of skill in the art that additional sanity checks may be added to the CM framework 100. For example, one sanity check might ensure the uniqueness of the proposed address (e.g., telephone number, short code, or USC) for a campaign within the starting and ending dates/times of the campaign.

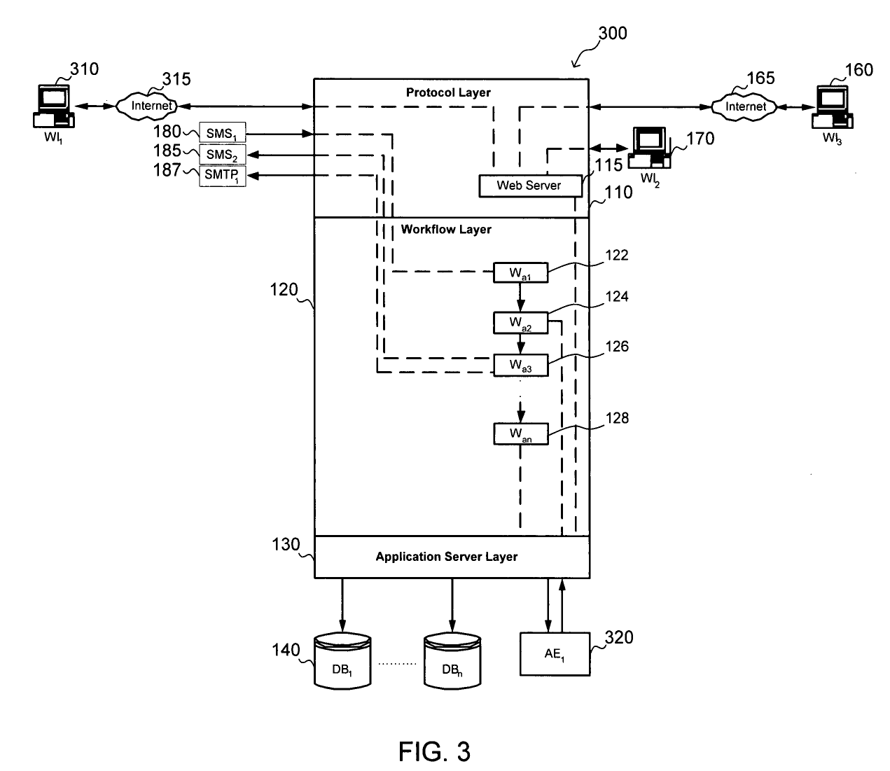

The CM framework 100 shown in FIG. 1 may be extended to support an interactive services initiative that offers an alert facility as shown in FIG. 3. FIG. 3 shows a CM frame work 300 similar to that shown in FIG. 1 where all similar components are designated by the same reference numerals.

In this context, a web-based interface 310 is employed to define and configure an alert offering, the details of which are recorded to the repository of provisioned alert offerings in one of the one or more databases 140 by accessing the CM framework 300 through an internet interface 315. An MS would employ the web-based interface 310 to register for a specific alert offering, with an interface supporting SMS message 180 being modified to support a two-way SMS-based MS registration and confirmation mechanism. An Alert Engine (AE) 320 preferably generates scheduled or event-driven outgoing alert notification messages based on, for example, pre-existing subscription information, MS-define ‘quiet periods,’ etc.

Additional extensions to the CM framework presented in FIGS. 1 and 3 may easily be realized to support other initiatives, such as, for example, two-way voting and mobile marketing. More specifically, definitional entries stored in the database for each campaign type drive the campaign-specific behavior or activity.

Those skilled in the art will appreciate that the campaign manager facility described herein may be one of several application based services (ABSs) that may be made available to users via a single portal or Content Gateway (CG) platform. Such a CG might include, e.g., a facility to construct a Multimedia Message Service (MMS)-based piece of content (e.g., a graphic image, a picture, a snippet of sound or music, etc.). This facility could then be accessed in the course of setting up a new campaign, such that the functionality of one ABS can be leveraged for another ABS, both available through a single Content Gateway (CG). Likewise, the CM ABS of the present invention may publish some or all (based on configurable parameters, security options, etc.) provisioned campaigns to the CG platform for inclusion in a general content ‘storefront’ that is visible through the CG platform. This storefront is preferably accessible to content providers, wireless carriers, etc., that are given the opportunity to browse through the several available ABSs. In a preferred implementation, interactions between a given ABS and the CG is effected through the exchange of XML documents.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A tiered system for allowing users to participate in a campaign using SMS messaging, the system comprising:
a first layer configured to receive information from a user via a user interface in response to an external stimulus;
a second layer configured to extract data relevant to the campaign from the information received by the first layer; and
a third layer configured to compare the extracted data to requirements of the campaign and, if the extracted data complies with the requirements of the campaign, to store the extracted data in a database associated with the campaign.

2. The system according to claim 1, wherein the second layer is configured to provide acknowledgment of the information to the user when the extracted data complies with the requirements of the campaign.

3. The system according to claim 1, wherein the second layer is configured to notify the user when the extracted data does not comply with the requirements of the campaign.

4. The system according to claim 1, wherein the user interface is configured to receive a text message that is addressed to one of a telephone number and a short code.

5. The system according to claim 4, wherein the one of the telephone number and the short code is a number assigned to the campaign for a duration of the campaign.

6. The system according to claim 1, wherein the first layer is configured to receive registration information from a user.

7. The system according to claim 6, wherein the registration information includes billing information.

8. The system according to claim 1, wherein the campaign is pre-configured by an entity other than the user.

9. The system according to claim 8, wherein the entity does not operate the system.

10. The system according to claim 1, wherein the campaign is one of a one-way voting campaign, a two-way voting campaign, a mobile marketing campaign, and an interactive service.

11. The system according to claim 1, wherein multiple campaigns overlap in time with another.

12. The system according to claim 1, wherein the system is accessible via a content gateway that offers a plurality of application based services, at least one of the application based services being leveraged for purposes of the campaign.

13. The system according to claim 1, further comprising at least one message engine that generates outgoing messages.

14. A method of operating a campaign manager operative to support a campaign employing SMS messaging, the method comprising:
receiving participant information via a user interface in response to an external stimulus;
extracting data relevant to a campaign from the information received via the user interface;
comparing the extracted data to requirements of the campaign and, if the extracted data complies with the requirements of the campaign, storing the extracted data in a database associated with the campaign.

15. The method according to claim 14, further comprising providing acknowledgment of the information to the user when the extracted data complies with the requirements of the campaign.

16. The method according to claim 14, further comprising notify the user when the extracted data does not comply with the requirements of the campaign.

17. The method according to claim 14, further comprising configuring the user interface to receive a text message that is addressed to one of a telephone number and a short code.

18. The method according to claim 17, further comprising assigning the one of the telephone number and the short code is a number assigned to the campaign for a duration of the campaign.

19. The method according to claim 18, further comprising receiving registration information from a user.

20. The method according to claim 19, wherein the registration information includes billing information.

21. The method according to claim 14, wherein the campaign is one of a one-way voting campaign, a two-way voting campaign, a mobile marketing campaign, and an interactive service.

22. The method according to claim 14, wherein the campaign was pre-configured by an entity other than the user.

23. The method according to claim 22, wherein the entity does not operate the system.

24. The method according to claim 22, wherein the entity can retrieve the extracted data from the database associated with the campaign.
